(19) United States
(12) Patent Application Publication
(10) Pub. No.: US 2007/0050543 A1
(43) Pub. Date: Mar. 1, 2007

(54) Storage of computer data on data storage devices of differing reliabilities

(76) Inventor: Ori Pomerantz, Austin, TX (US)

Correspondence Address: INTERNATIONAL CORP (BLF), c/o BIGGERS & OHANIAN, LLP, P.O. BOX 1469, AUSTIN, TX, 78767-1469, US

(21) Appl. No.: 11/216,967

(22) Filed: Aug. 31, 2005

(51) Int. Cl. G06F 12/00

(52) U.S. Cl. 711/114

(57) ABSTRACT

Methods, systems, and computer program products are disclosed for storage of computer data on data storage devices of differing reliabilities that include maintaining a usage statistic for each block of data stored on each data storage device of a system and moving a block of computer data from a first data storage device to a second data storage device in dependence upon the usage statistic for the moved block and the reliabilities of the first and second data storage devices. Embodiments may include storing by a storage reliability controller blocks of data at storage locations on the data storage devices. Such a storage reliability controller may implement a layer of storage virtualization in an operating system of a computer system. Embodiments typically include mapping by a storage reliability controller block identifiers of the storage reliability controller to storage locations of the data storage devices.

### BACKGROUND OF THE INVENTION

1. Field of the Invention

The field of the invention is data processing, or, more specifically, methods, systems, and products for storage of computer data on data storage devices of differing reliabilities.

2. Description of Related Art

The development of the EDVAC computer system of 1948 is often cited as the beginning of the computer era. Since that time, computer systems have evolved into extremely complicated devices. Today's computers are much more sophisticated than early systems such as the EDVAC. The most basic requirements levied upon computer systems, however, remain little changed. A computer system's job is to access, manipulate, and store information. Computer system designers are constantly striving to improve the way in which a computer system can deal with information.

Modern computer systems, especially enterprise systems, store huge quantities of computer data on sophisticated storage systems that include SANs (Storage Area Networks), disk arrays including RAID (Redundant Arrays of Independent Disks) sets, redundant storage sets, tape libraries, and so on. Such systems provide reliability of disk storage by use of redundancy, but redundancy in a disk drive is limited in its ability to restore a lost disk without losing data or requiring backup from tape. A typical RAID set, for example, loses all data stored on it and requires backup from tape if two disks of the set fail at the same time. Unrecoverable data loss may be a disaster, and retrieving computer data from tape backup is an expensive process, often requiring human intervention. In addition, in typical systems today, data is distributed on disk drives of a file system with no regard for the frequency with which the data is used or the reliability of a particular storage device. That is, in typical systems today, computer data that is rarely used, and therefore could inexpensively wait for tape backup, is stored on the same storage device with data that is frequently used, regardless of the reliability of the storage device.

### SUMMARY OF THE INVENTION

Methods, systems, and computer program products are disclosed for storage of computer data on data storage devices of differing reliabilities that include maintaining a usage statistic for each block of data stored on each data storage device of a system and moving a block of computer data from a first data storage device to a second data storage device in dependence upon the usage statistic for the moved block and the reliabilities of the first and second data storage devices. Embodiments may include storing by a storage reliability controller blocks of data at storage locations on the data storage devices. Such a storage reliability controller may implement a layer of storage virtualization in an operating system of a computer system. Embodiments typically include mapping by a storage reliability controller block identifiers of the storage reliability controller to storage locations of the data storage devices.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a network diagram illustrating an exemplary system for redundant storage of computer data according to embodiments of the present invention.

FIG. 2 sets forth a block diagram illustrating an exemplary system for redundant storage of computer data according to embodiments of the present invention.

FIG. 3 sets forth a block diagram of automated computing machinery comprising an exemplary computer useful in redundant storage of computer data according to embodiments of the present invention.

FIG. 4 sets forth a flow chart illustrating an exemplary method for redundant storage of computer data according to embodiments of the present invention.

FIG. 5 sets forth a flow chart illustrating a further exemplary method for redundant storage of computer data according to embodiments of the present invention.

FIG. 6 sets forth a table illustrating Galois addition and Galois for values that fit into 4 bits of binary storage.

FIG. 7 sets forth a table illustrating Galois multiplication function for 4-bit values.

FIG. 8 sets forth a table illustrating Galois division for values that can be represented with 4 binary bits.

FIG. 9 sets forth an example of an encoding table for the case of N=2, M=7, for the 7 linear expressions A, B, A+B, A+2B, A+3B, 2A+B, 3A+B, where the calculation of the values in the table is carried out in 4-bit Galois math.

FIG. 10 sets forth an example of a decoding table for the case of N=2 for decoding values encoded with the 2 linear expressions 2A+B and A+2B where the calculation of the values in the table is carried out in 4-bit Galois math.

FIG. 11 sets forth a network diagram illustrating an exemplary system for storage of computer data on data storage devices of differing reliabilities according to embodiments of the present invention.

FIG. 12 sets forth a block diagram of automated computing machinery comprising an exemplary computer useful in storage of computer data on data storage devices of differing reliabilities according to embodiments of the present invention.

FIG. 13 sets forth a flow chart illustrating an exemplary method for storage of computer data on data storage devices of differing reliabilities according to embodiments of the present invention.

FIG. 14 sets forth a flow chart illustrating an exemplary method for moving a block of computer data from a first data storage device to a second data storage device in dependence upon the usage statistic for the moved block and the reliabilities of the first and second data storage devices.

### DETAILED DESCRIPTION OF EXEMPLARY EMBODIMENTS

### Introduction

Exemplary methods, systems, and products for redundant storage of computer data according to embodiments of the present invention are described below in this specification. Two kinds of data storage devices are described in this specification, RAID sets and redundant storage sets. A RAID set is a Redundant Array of Independent Disks. A redundant storage set, as the term is used here, is a set of redundant storage devices, described in more detail below, that carries out redundant storage of computer data by encoding N data values through M linear expressions into M encoded data values, storing each encoded data value separately on one of M redundant storage devices, where M is greater than N and none of the linear expressions is linearly dependent upon any group of N−1 of the M linear expressions. The M redundant storage devices are referred to as a ‘redundant storage set.’ The selection for description of these two types of data storage device is for clarity of explanation, not for limitation of the invention. Methods, systems, and products for redundant storage of computer data according to embodiments of the present invention may be implanted with any kind of data storage device that may occur to those of skill in the art.

### Redundant Storage Devices

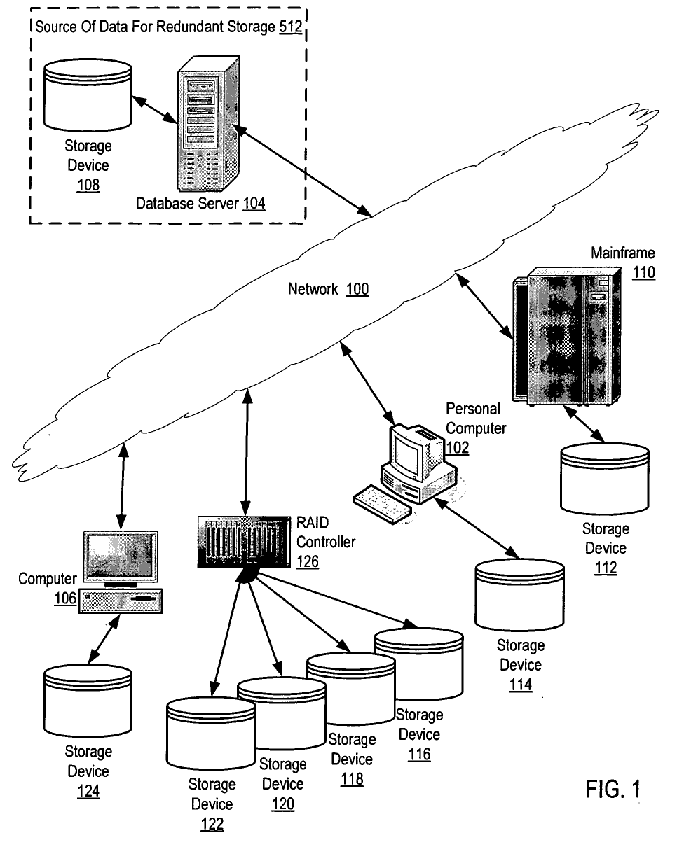

Exemplary methods, systems, and products for redundant storage of computer data according to embodiments of the present invention are described with reference to the accompanying drawings, beginning with FIG. 1. FIG. 1 sets forth a network diagram illustrating an exemplary system for redundant storage of computer data according to embodiments of the present invention. As explained in more detail below, the system of FIG. 1 operates generally to carry out redundant storage of computer data according to embodiments of the present invention by encoding N data values through M linear expressions into M encoded data values, storing each encoded data value separately on one of M redundant storage devices, where M is greater than N and none of the linear expressions is linearly dependent upon any group of N−1 of the M linear expressions.

Data for redundant storage is any computer data that may usefully be stored, for backup purposes, for example, on unreliable media. Unreliable media are any storage media from which stored data is not guaranteed to be completely recoverable. Encoding N data values through M linear expressions into M encoded data values, one data value for each linear expression, when repeated for many data values, may be viewed as producing M streams of encoded data for storage on M redundant storage devices. Each of the N data values can be recovered from storage, so long as at least N of the encoded values can be recovered. In an example where N=2 and M=7, the encoded data is stored on 7 redundant storage devices, and all the data is recoverable if the encoded data is recoverable from only two of the redundant storage devices. The other 5 redundant storage device may be off-line, damaged, or even destroyed. The data is still recoverable if two of them are available. That is how the risk of using unreliable media is reduced with redundancy.

The system of FIG. 1 includes a source of data for redundant storage (512) represented as a database server (104) that implements persistent data storage with storage device (108). Database server (104) is coupled for data communications to other computers through network (100). Also coupled to network (100) for data communications are several other computers including desktop computer (106), RAID (Redundant Array of Independent Disks) controller (126), personal computer (102), and mainframe computer (110). The system of FIG. 1 also includes redundant storage devices (112-124). The redundant storage devices are ‘redundant storage devices’ in the sense that portions of their storage media are made available for redundant storage of data from source (512) through improvements according to embodiments of the present invention in desktop computer (106), RAID controller (126), personal computer (102), and mainframe computer (110).

The arrangement of servers and other devices making up the exemplary system illustrated in FIG. 1 are for explanation, not for limitation. Data processing systems useful according to various embodiments of the present invention may include additional servers, routers, other devices, and peer-to-peer architectures, not shown in FIG. 1, as will occur to those of skill in the art. Networks in such data processing systems may support many data communications protocols, including for example TCP/IP, HTTP, WAP, HDTP, and others as will occur to those of skill in the art. Various embodiments of the present invention may be implemented on a variety of hardware platforms in addition to those illustrated in FIG. 1.

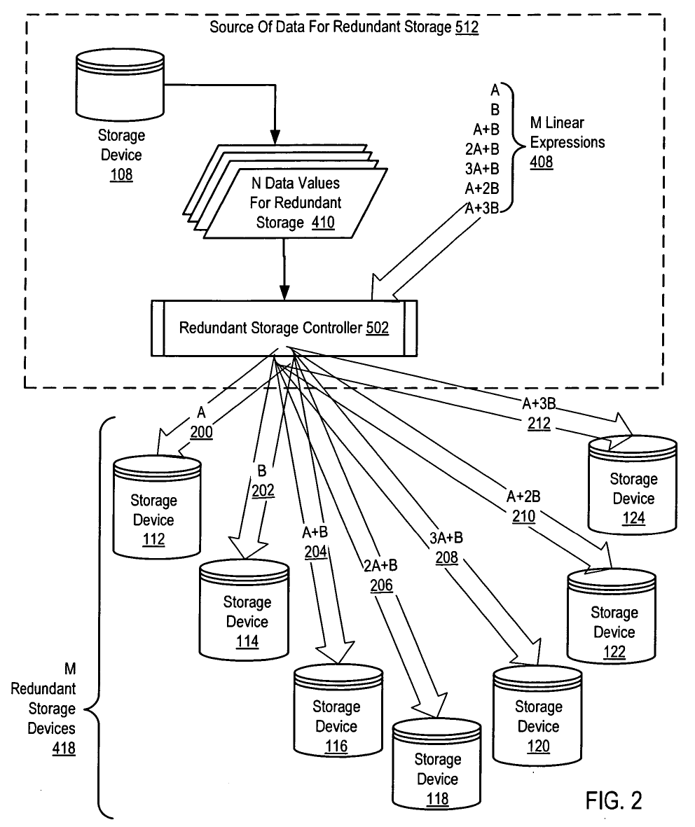

For further explanation, FIG. 2 sets forth a block diagram illustrating an exemplary system for redundant storage of computer data according to embodiments of the present invention. The system of FIG. 2 includes a redundant storage controller (502), a software module programmed to carry out redundant storage of computer data according to embodiments of the present invention. Redundant storage controller (502) operates generally to carry out redundant storage of computer data according to embodiments of the present invention by encoding N data values through M linear expressions into M encoded data values, storing each encoded data value separately on one of M redundant storage devices, where M is greater than N and none of the linear expressions is linearly dependent upon any group of N−1 of the M linear expressions. A linear expression is an expression of the form xa+yb+z where a and b are variables and x, y, and z are constants. In the example of FIG. 2, M is set to 7, and N is set to 2. With M=7 and N=2, data values for redundant storage (410) from storage device (108) are encoded in this example using the 7 linear expressions (408) A, B, A+B, 2A+B, 3A+B, A+2B, and A+3B, each of which is formed with two variables, A and B. (The linear expression A is formed from A and B with B multiplied by zero; the linear expression B is formed from A and B with A multiplied by zero.)

Redundant storage controller (502), by encoding a stream of N data values from storage device (108) through M linear expressions into M encoded data values and storing each encoded data value separately on one of M redundant storage devices produces, in this example because M=7, 7 streams of encoded data, one for each of the 7 linear expressions. The redundant storage controller directs each stream of encoded data to a separate redundant storage device. That is:
the stream of data encoded through linear expression A is stored through stream (200) on storage device (112);
the stream of data encoded through linear expression B is stored through stream (202) on storage device (114);
the stream of data encoded through linear expression A+B is stored through stream (204) on storage device (116);
the stream of data encoded through linear expression 2A+B is stored through stream (206) on storage device (118);
the stream of data encoded through linear expression 3A+B is stored through stream (208) on storage device (120);
the stream of data encoded through linear expression A+2B is stored through stream (210) on storage device (122); and
the stream of data encoded through linear expression A+3B is stored through stream (212) on storage device (124).

Redundant storage controller (502) encodes the data values (410) through M linear expressions (408) into M encoded data values by calculating values for the expressions. Given data values A=5 and B=6 with N=2 and M=7, for example, redundant storage controller (502) encodes the data values by calculating values for each of the 7 expressions:
A=5
B=6
A+B=11
2A+B=16
3A+B=21
A+2B=17
A+3B=23

In this example, redundant storage controller (502) stores the encoded value for A on storage device (112), the encoded value for B on storage device (114), the encoded value for A+B on storage device (116), and so on, storing each encoded data value separately on one of M redundant storage devices (418). Then redundant storage controller (502) repeats the encoding process for the next N data values in the stream of data for redundant storage from storage device (108), and then repeats again for the next N data values, and again, and again, creating M streams of encoded values for redundant storage on M redundant storage devices according to M linear expressions.

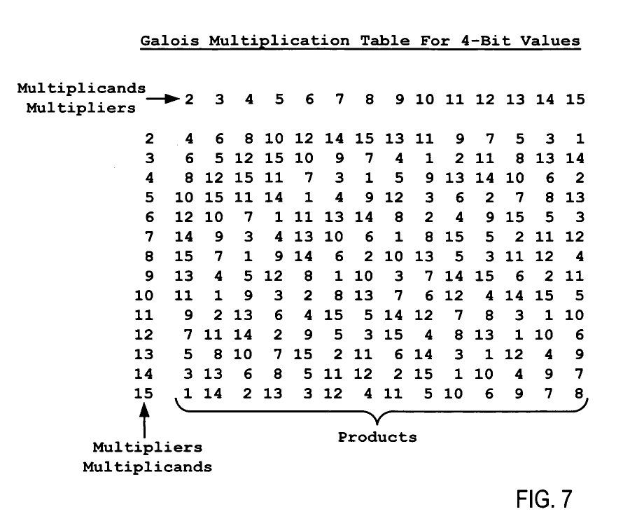

All the data is recoverable so long as at least N of the redundant storage devices remain operable. In the example, of FIG. 2, if storage devices (112, 114, 116, 118, and 120) are all unavailable, off-line, damaged, for any reason, and only storage devices (122) and (124) remain to support recovery of redundant data storage, all the data can be recovered. Recovering the encoded data from storage devices (122) and (124) in this example recovers the data encoded as A+2B and A+3B. Continuing with the example of two data values A=5 and B=6, both can be recovered by linear algebra. Recover B by subtracting the two expressions:
A+3B=23
A+2B=17
to obtain B=6, and then substitute B=6 into A+2B=17 as A+2(6)=17 to obtain A=17−12=5. Encoded data from any 2 of the 7 storage devices in the particular example of FIG. 7 can be recovered by linear algebra, and in the general case, encoded data from any N of M storage devices in the particular can be recovered by application of linear algebra—so long as N is less than M and, as explained in more detail below, none of the linear expressions used for encoding is linearly dependent upon any group of N−1 of the M linear expressions.

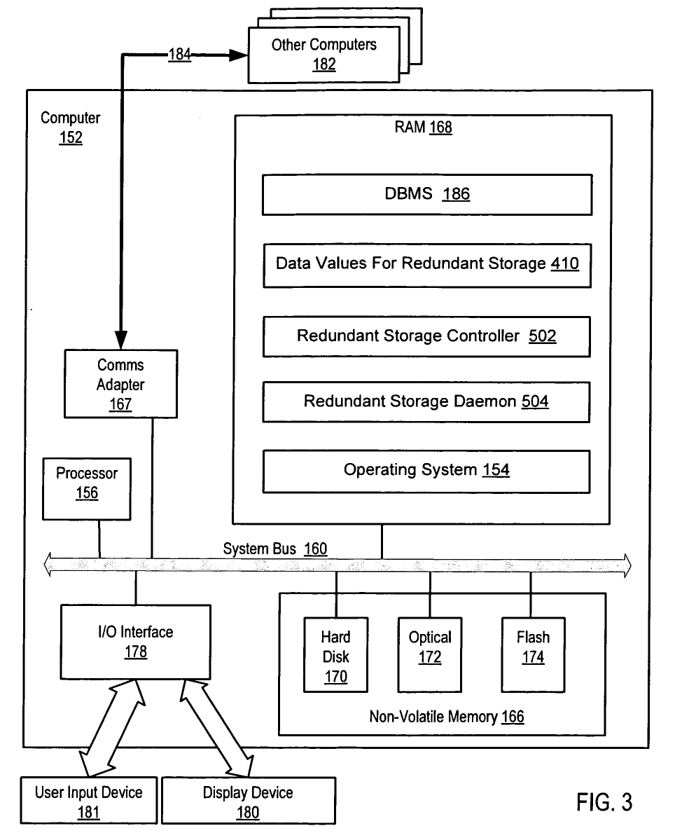

Redundant storage of computer data in accordance with embodiments of the present invention is generally implemented with computers, that is, with automated computing machinery. In the system of FIG. 1, for example, all the nodes, the database server, the storage devices, the RAID controller, and so on, are implemented to some extent at least as computers. For further explanation, therefore, FIG. 3 sets forth a block diagram of automated computing machinery comprising an exemplary computer (152) useful in redundant storage of computer data according to embodiments of the present invention. The computer (152) of FIG. 3 includes at least one computer processor (156) or ‘CPU’ as well as random access memory (168) (‘RAM’) which is connected through a system bus (160) to processor (156) and to other components of the computer.

Stored in RAM (168) is a database management system (‘DBMS’) (186) of a kind that may serve as a source of data for redundant storage by operating a database through a database server such as the one illustrated at reference (104) on FIG. 1. Also stored in RAM are data values for redundant storage (410). Also stored in RAM is a redundant storage controller, a set of computer program instructions that implement redundant storage of computer data according to embodiments of the present invention by encoding data values through linear expressions and storing the encoded data values on redundant storage devices according to embodiments of the present invention. Also stored in RAM (168) is a redundant storage daemon, a set of computer program instructions that implement redundant storage of computer data according to embodiments of the present invention by monitoring and indicating the unused portion of storage space on a redundant storage device, writing encoded data to an unused portion of storage space on a redundant storage device, and reducing encoded storage on the redundant storage device when free storage space is less than a predetermined threshold amount.

Also stored in RAM (168) is an operating system (154). Operating systems useful in computers according to embodiments of the present invention include UNIX™, Linux™, Microsoft NT™, AIX™, IBM's i5/OS™, and others as will occur to those of skill in the art. Operating system (154), DBMS (186), data values for redundant storage (410), redundant storage controller (502), and redundant storage daemon (504) in the example of FIG. 3 are shown in RAM (168), but many components of such software typically are stored in non-volatile memory (166) also.

Computer (152) of FIG. 3 includes non-volatile computer memory (166) coupled through a system bus (160) to processor (156) and to other components of the computer (152). Non-volatile computer memory (166) may be implemented as a hard disk drive (170), optical disk drive (172), electrically erasable programmable read-only memory space (so-called ‘EEPROM’ or ‘Flash’ memory) (174), RAM drives (not shown), or as any other kind of computer memory as will occur to those of skill in the art.

The example computer of FIG. 3 includes one or more input/output interface adapters (178). Input/output interface adapters in computers implement user-oriented input/output through, for example, software drivers and computer hardware for controlling output to display devices (180) such as computer display screens, as well as user input from user input devices (181) such as keyboards and mice.

The exemplary computer (152) of FIG. 3 includes a communications adapter (167) for implementing data communications (184) with other computers (182), including, for example, redundant storage devices. Such data communications may be carried out through serially through RS-232 connections, through external buses such as USB, through data communications networks such as IP networks, and in other ways as will occur to those of skill in the art. Communications adapters implement the hardware level of data communications through which one computer sends data communications to another computer, directly or through a network. Examples of communications adapters useful for determining availability of a destination according to embodiments of the present invention include modems for wired dial-up communications, Ethernet (IEEE 802.3) adapters for wired network communications, and 802.11b adapters for wireless network communications.

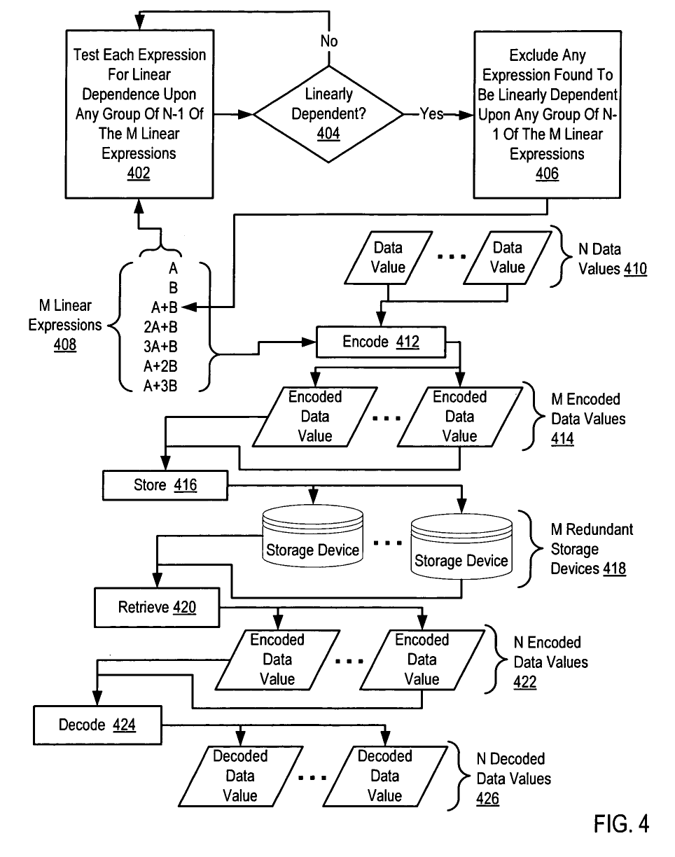

For further explanation, FIG. 4 sets forth a flow chart illustrating an exemplary method for redundant storage of computer data according to embodiments of the present invention that includes encoding (412) N data values (410) through M linear expressions (408) into M encoded data values (414) and storing (416) each encoded data value separately on one of M redundant storage devices (418). In the method of FIG. 4, M is greater than N, and none of the linear expressions is linearly dependent upon any group of N−1 of the M linear expressions.

Encoding with standard arithmetic results in values for linear expressions that vary in their storage requirements. Recall from the example above that data values A=5 and B=6 with N=2 and M=7 may be encoded with the 7 linear expressions A, B, A+B, 2A+B, 3A+B, A+2B, and A+3B as:
A=5
B=6
A+B=11
2A+B=16
3A+B=21
A+2B=17
A+3B=23

Readers will observe that the value of the expression A=5 can be stored in four binary bits as 0101, and the value of the expression B=6 can be stored in four binary bits as 0110. The binary value of A+B=11 fits in four bits: 1011. The binary value of the expression 2A+B=16, however, requires more than four bits of storage: 10000. It is more difficult to synchronize streams of recovery data from redundant storage devices if the encoded values are of various sizes.

In the method of FIG. 4, encoding (412) N data values (410) through M linear expressions (408) into M encoded data values (414) may be carried out by calculating values for the expressions with Galois arithmetic. Galois arithmetic is an arithmetic whose values always fit into the same quantity of binary storage. The quantity of storage may be varied according to the application, 4 bits, 8 bits, 24 bits, and so on, as will occur to those of skill in the art. That is, in the method of FIG. 4, encoding (412) data values (410) may be carried out by encoding data values in units of four bits per value, the advantages of which are clarified in the description set forth below in this specification.

Galois addition is defined as a Boolean exclusive-OR operation, ‘XOR.’ Galois subtraction also is defined as a Boolean exclusive-OR operation, ‘XOR.’ That is, Galois addition and Galois subtraction are the same operation. In Galois math, A+B=B+A=A−B=B−A. XORing values expressed in the same number of binary bits always yields a value that can be expressed in the same number of binary bits. Examples include:

$$XOR \frac{\begin{matrix}0001 \\ 0001\end{matrix}}{0000} XOR \frac{\begin{matrix}0001 \\ 0010\end{matrix}}{0011} XOR \frac{\begin{matrix}1010 \\ 0101\end{matrix}}{1111}$$

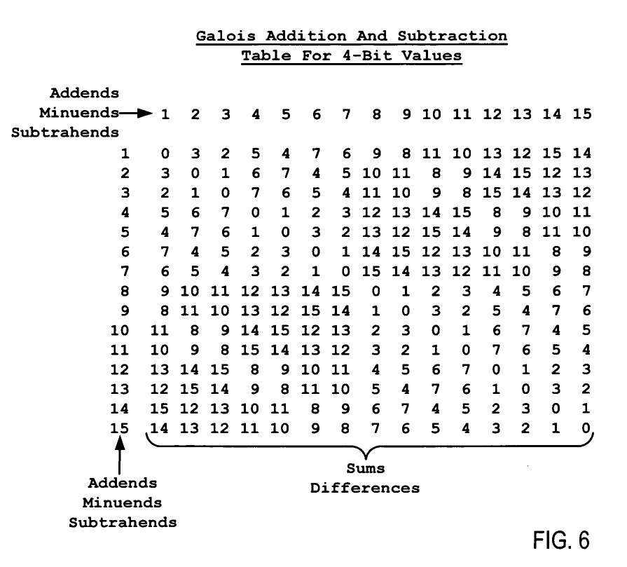

There are only 16 possible values that can be expressed in 4 binary bits, 0-15. The table in FIG. 6 therefore sets forth the entire Galois addition function and the entire Galois subtraction function for values that fit into 4 bits of binary storage. In the table of FIG. 6, values in the top row represent addends, minuends, or subtrahends, and values in the leftmost column also represent addends, minuends, or subtrahends. Sums and differences are represented in the other rows and columns. Each sum of two addends is at the intersection of a row and column identified by the addends. Each difference of a minuend and subtrahend is at the intersection of a row and column identified by the minuend and subtrahend. From the table of FIG. 6, therefore, in Galois addition: 6+4=2, 2+10=8, 7+13=10, 11+7=12, 15+14=1, and so on. From the table of FIG. 6, in Galois subtraction: 6−4=2, 4−6=2, 7−12=11, 4−10=14, 14−3=13, and so on.

Just as the table in FIG. 6 sets forth the entire Galois addition function for all 4-bit values, so the table in FIG. 7 sets forth the entire Galois multiplication function for all 4-bit values. The values in the topmost row of the table in FIG. 6 and the values in the leftmost column are multipliers or multiplicands. The values in the other rows and columns are products. Each product of a multiplicand and a multiplier is at the intersection of a row and column identified by the multiplicand and a multiplier.

From the table of FIG. 6, therefore, in Galois multiplication: 6×4=7, 2×10=11, 7×13=2, 11×7=15, 15×14=7, and so on.

The multiplication table of FIG. 7 is created by use of multiplication with a ‘generator.’ A generator is a quantity chosen so that multiplication is reversible.

That is, when doing Galois multiplication on values of k bits, the generator is a 1+k bit number (a number equal to or larger than 2^{k} and smaller than 2^{k+1} chosen so that multiplication is reversible. Reversible multiplication is multiplication so that if ab=ac then either a=0 or b=c. The table of FIG. 7 was created with a generator of value 31.

According to the table of FIG. 7, decimal 10×10=7. The following demonstrates how to multiply 10×10 in Galois arithmetic and therefore how to create the table of FIG. 7. First, express the values to be multiplied in binary, then multiply, using XOR instead of addition:

$$\begin{matrix}\begin{matrix}\begin{matrix}\begin{matrix} 1010 \\ x \underline{ 1010}\end{matrix} \\ 1010000\end{matrix} \\ xor \underline{10100}\end{matrix} \\ 1000100\end{matrix}$$

The result is a 7-bit value, which is reduced to a 4-bit value by XORing the result with the value of the generator multiplied by 2^{k}, where k is the appropriate value to zero out the multiplication result:

$$1000100$$

$$xor \underline{1111100} = generator ⨯ {2}^{2}$$

$$0111000$$

This result, 111100, is a 6-bit value, still not a 4-bit value. The size of the value is again reduced, this time by XORing the result with the value of the generator multiplied by 2¹:

$$0111000$$

$$xor \underline{111110} = generator ⨯ {2}^{1}$$

$$000110$$

Which is six, a value that fits into 4-bits. In Galois arithmetic, therefore, 10×10=6. All the other products in the table of FIG. 7 are created by the same use of the generator, 2×2=4 . . . 2×15=1, 3×2=6 . . . 3×15=14, and so on. Readers will recognize in view of this explanation, that Galois multiplication by use of a table makes more efficient use of computer resources because calculating a product of a multiplier and a multiplicand in Galois arithmetic typically will take much longer than a table lookup.

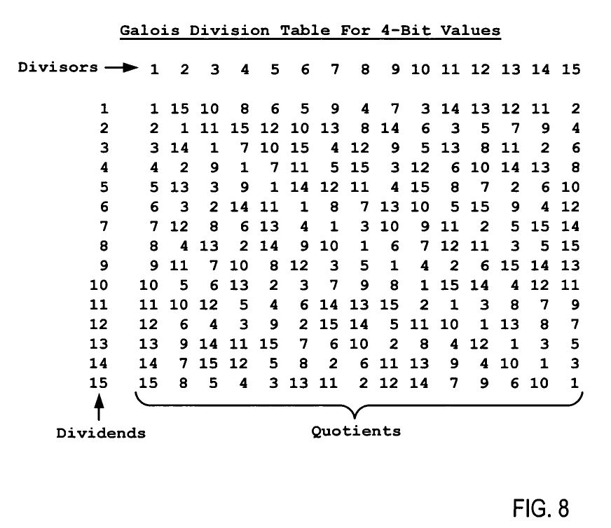

Galois division is a true inverse of Galois multiplication. It is therefore possible to use the multiplication table of FIG. 7 for division. For convenience of reference, however, the Galois division table of FIG. 8 is created by rearranging the values in the table of FIG. 7 so that values for dividends and divisors are located in the leftmost column and the top row respectively. The values in the other rows and columns are quotients. Each quotient of a dividend divided by a divisor is at the intersection of a row and column identified by the dividend and the divisor. The table in FIG. 8 sets forth the entire Galois division function for all values that can be represented with 4 binary bits. From the table of FIG. 8, therefore, in Galois division: 6÷4=14, 2÷10=6, 7÷13=5, 11÷7=14, 15÷14=10, and so on.

Because calculations can be performed in Galois arithmetic with values that never exceed 4 binary bits in size, efficient lookup tables may be constructed. Each of the addition, multiplication, and division tables in FIGS. 6, 7, and 8 contains only about 256 values each of which is expressed in only 4 bits—so that a complete Galois math may be expressed in less than half a kilobyte. In addition to the arithmetic tables, efficient tables for encoding and decoding through linear expressions also may be constructed.

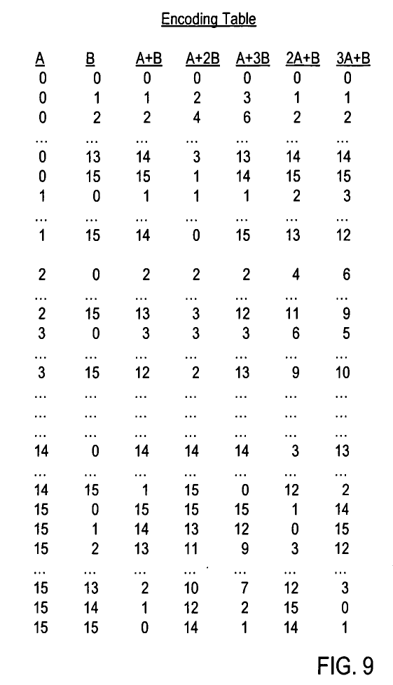

FIG. 9 sets forth an example of an encoding table for the case of N=2, M=7, for the 7 linear expressions A, B, A+B, A+2B, A+3B, 2A+B, 3A+B, where the calculation of the values in the table is carried out in 4-bit Galois math. Because there are only 256 possible combinations of the N=2 data values of 0-15, such a table requires only 256 rows—and 1 column for each of the M=7 linear expressions used for encoding. In the case of N=2, M=7, such a table requires 256×7=1792 entries each of which occupies only 4 bits of storage so that the entire encoding table fits into less than 1 kilobyte of memory. Encoding is carried out with such a table by looking up a value for an expression according to the N (=2, in this example) data values to be encoded. In this example:
the encoded value for the data values A=3 and B=15 encoded through A+2B is 2,
the encoded value for the data values A=0 and B=2 encoded through A+3B is 6,
the encoded value for the data values A=14 and B=15 encoded through 2A+B is 12,
the encoded value for the data values A=15 and B=2 encoded through A+B is 13,
the encoded value for the data values A=15 and B=14 encoded through 3A+B is 1,
and so on.

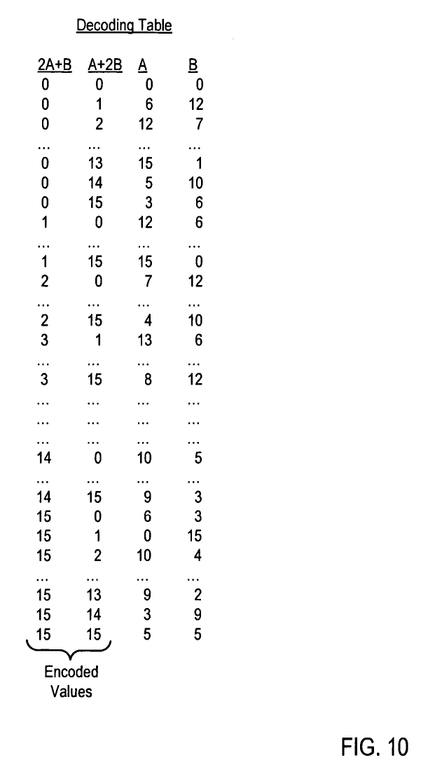

FIG. 10 sets forth an example of a decoding table for the case of N=2 for decoding values encoded with the 2 linear expressions 2A+B and A+2B where the calculation of the values in the table is carried out in 4-bit Galois math. Because there are only 256 possible combinations of the N=2 data values of 0-15, such a table requires only 256 rows, 1 column for each linear expression used to decode, and 1 column for each of the N=2 data values to be retrieved through decoding. All values in the table occupy only 4 bits of memory, so the size of such a table in bytes is only 512 bytes. In order to provide a set of such tables for decoding any combination of N encoded values encoded with any of M linear expressions, M!/N!(M−N)! tables are needed. In the case of N=2, M=7,

$$\frac{M !}{N ! ( M - N ) !} = \frac{7 !}{2 ! ( 5 ! )} = \frac{7 ( 6 )}{2} = 21$$

At 512 bytes per table, therefore, all the decoding for the case of N=2, M=7, can be done with tables occupying less than 11 kilobytes of memory.

Decoding is carried out with such a table by a lookup on encoded values. In the table of FIG. 10, the encoded values are in the columns labeled 2A+B and A+2B. Decoding with the table in FIG. 10 yields, for example:
the data values decoded from the encoded values 2A+B=0 and A+2B=1 are A=6 and B=12,
the data values decoded from the encoded values 2A+B=0 and A+2B=14 are A=5 and B=10,
the data values decoded from the encoded values 2A+B=3 and A+2B=15 are A=8 and B=12,
the data values decoded from the encoded values 2A+B=14 and A+2B=15 are A=9 and B=3,
the data values decoded from the encoded values 2A+B=15 and A+2B=14 are A=3 and B=9,
and so on.

Again with reference to FIG. 4: The method of FIG. 4 also includes retrieving (420) encoded data values (422) from storage in redundant storage devices (418) and decoding (424) the encoded data values (422), thereby producing N decoded data values (426) that are the same N data values (410) that were earlier encoded and stored on M redundant storage devices. As explained above, encoded values need be retrieved from only N of the M redundant storage devices for all of the original data values to be recovered. The encoded data may be decoded by techniques of linear algebra as explained above or by table lookups on tables generated as described above.

As mentioned above, in the method of FIG. 4, none of the linear expressions is linearly dependent upon any group of N−1 of the M linear expressions. The method of FIG. 4 therefore also includes testing (402) each of the M linear expressions (408) for linear dependence (404) upon each group of N−1 of the M linear expressions and excluding (406) from the M linear expressions any expression found to be linearly dependent upon any group of N−1 of the M linear expressions. In the method of FIG. 4, one of the M linear expressions e* is linearly dependent upon a group of N−1 of the M linear expressions if:

$${e}^{*} = {\sum }_{i = 1}^{n - 1} {a}_{i} {e}_{i} ,$$

where aᵢ is any linear coefficient, eᵢ is one of the M linear expressions, and N is the number of data values to be encoded. A practical way to test for linear dependence therefore is to generate a table like the one illustrated in FIG. 9 containing all the values for all M linear expressions calculated for all values of the N data values to be encoded and scan the table to determine whether, for two different sets of N values, there is a subset of N linear expressions (out of the M linear expressions in total) which results in the same values. If such a subset exists, one of the expressions in the subset is excluded from the M linear expressions. An additional linear expression may be substituted to bring the number of linear expressions back up to M.

For further explanation, here is an example of linear dependence for the case of N=3:

| A | B | C | A + B + C | A + 2B + 2C |
|---|---|---|---|---|
| 0 | 1 | 0 | 1 | 2 |
| 0 | 0 | 1 | 1 | 2 |

The subset (A, A+B+C, A+2B+2C) encodes both of the lines above (0, 1, 0) and (0, 0, 1) into the same values: (0, 1, 2). In other words, taking e₁=A, e₂=A+B+C, and e*=A+2B+2C, then e*=e₁+2E₂. The subset (A, A+B+C, A+2B+2C) therefore is linearly dependent, and one of the expressions in the subset needs to be removed.

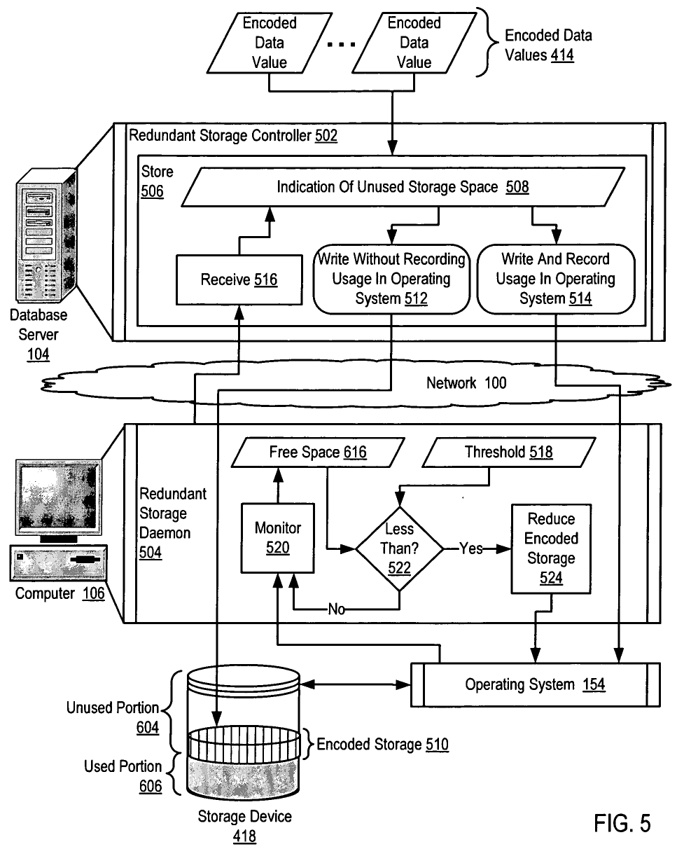

For further explanation, FIG. 5 sets forth a flow chart illustrating a further exemplary method for redundant storage of computer data according to embodiments of the present invention that includes storing (506) encoded data (414) by a redundant storage controller (502) to a redundant storage device (418) in a computer (106) coupled for data communications through a network (100) to the redundant storage controller (502). In this example, database server (104) serves as a source of data values for redundant storage, and computer (106) serves as a redundant storage resource. Database server (104) is coupled for data communications with computer (106) through data communications network (100). Redundant storage controller (502) is installed on database server (104). Redundant storage controller (502) is a software module containing computer program instructions for redundant storage of computer data according to embodiments of the present invention. Computer (106) includes a redundant storage daemon (504), a software module that carries out data communications with redundant storage controller (502) and other functions also, described in more detail below. Computer (106) also includes redundant storage device (418) and operating system (154).

The method of FIG. 5 also includes receiving (516) in a redundant storage controller (502) from a communicatively coupled computer (106) an indication (508) of a portion of unused storage space (604) on a redundant storage device (418). In this example, the redundant storage daemon (504) monitors the portion of unused storage space on redundant storage device (418) and periodically reports the portion of unused storage space to redundant storage controller (502) on database server (104).

In the example of FIG. 5, a redundant storage controller (502) stores (506) encoded data by writing (514) the encoded data (414) to an unused portion (604) of storage media on redundant storage device (418). Redundant storage device (418) is controlled by an operating system (154), including recording in the operating system that the portion of storage media is now in use for storage of encoded data (510). In the example of FIG. 5, the redundant storage daemon may monitor (520) the amount of free storage space on the redundant storage device (418) and reduce (524) encoded storage on the redundant storage device when free storage space (616) is less than a predetermined threshold amount (518). Monitoring (520) the amount of free storage space on the redundant storage device (418) may be carried out by calls to operating system (154), and reducing (524) encoded storage on the redundant storage device when free storage space (616) is less than a predetermined threshold amount (518) may be carried out by calling the operating system to delete data in encoded storage (510). In such a case, encoded storage (510) is in standard operating system file structures known to the operating system, but the redundant storage daemon reduces encoded storage without informing the redundant storage controller of the reduction, thereby implementing unreliable storage. Reliability is improved according to embodiments of the present invention with redundancy.

Alternatively in the example of FIG. 5, storing (506) encoded data may be carried out by writing (512) the encoded data (414) to an unused portion (604) of storage media on a redundant storage device (418), where the redundant storage device is controlled by an operating system (154), and the writing of the encoded data is implemented without recording in the operating system the fact that the portion of storage media now has encoded data stored upon the portion of storage media (510). Writing encoded data without recording storage media usage in the operating system may be carried out, for example, in hardware by a disk drive controller (not shown) which is controlled directly by a software module such as the redundant storage daemon (504) programmed to call the controller directly without calling the operating system, so that the operating system remains unaware of the encoded storage. Alternatively, the operating system may be provided with additional API (‘Application Programming Interface’) functions, or improved versions of current functions, that write encoded data to unused portions of storage media without recording the usage in the usual data structures of the operating system. Readers will recognize that encoded data written to unused portion of storage media risk being overwritten by the operating system's standard writing functions because the standard writing functions have no way of knowing that unused portions have in fact been ‘used’ to store encoded data. Again, this implements unreliable media with reliability improved with redundancy according to embodiments of the present invention.

### Storage of Computer Data on Devices of Differing Reliabilities

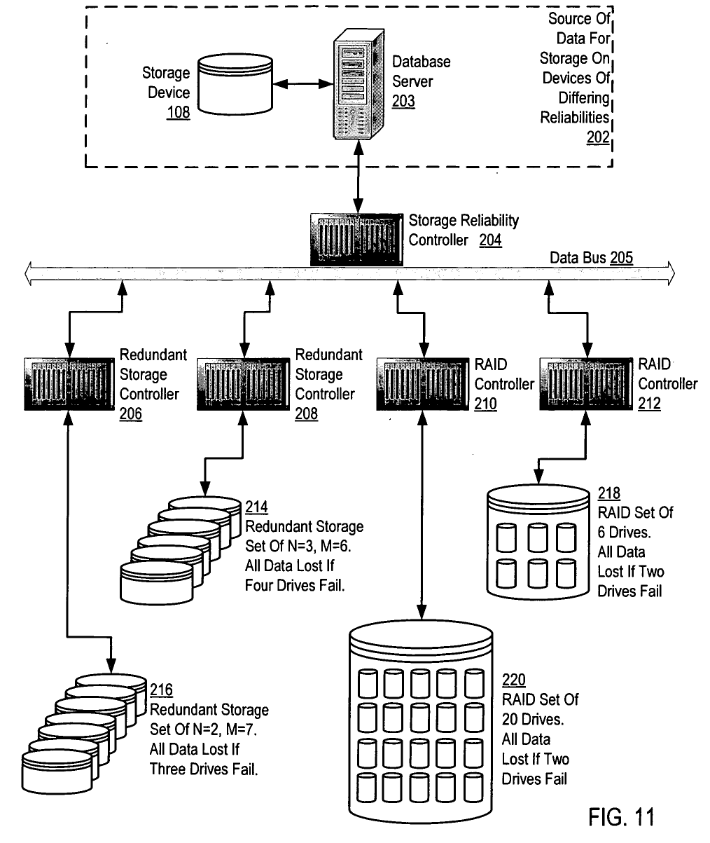

Exemplary methods, systems, and products for storage of computer data on data storage devices of differing reliabilities according to embodiments of the present invention are described with reference to the accompanying drawings, beginning with FIG. 11. FIG. 11 sets forth a network diagram illustrating an exemplary system for storage of computer data on data storage devices of differing reliabilities according to embodiments of the present invention. As explained in more detail below, the system of FIG. 11 operates generally to carry out storage of computer data on data storage devices of differing reliabilities according to embodiments of the present invention by providing data storage devices where each data storage device having blocks of computer data stored at storage locations on the data storage device and the data storage devices characterized by differing reliabilities, maintaining a usage statistic for each block of data stored on each data storage device, and moving a block of computer data from a first data storage device to a second data storage device in dependence upon the usage statistic for the moved block and the reliabilities of the first and second data storage devices.

The system of FIG. 11 includes a source of data for redundant storage (202) represented as a database server (203) that implements storage of computer data on data storage devices of differing reliabilities by use of storage reliability controller (204). Data storage devices of differing reliabilities are represented in this example by redundant storage sets (214, 216) and RAID sets (218, 220). Redundant storage sets are storage devices that make portions of their storage media available for redundant storage of data from source (202) through redundant storage controllers (206, 208). Redundant storage controllers (206, 208) are controllers of redundant storage sets, described in detail above in this specification, that carry out redundant storage of computer data by encoding N data values through M linear expressions into M encoded data values, storing each encoded data value separately on one of M redundant storage devices, where M is greater than N and none of the linear expressions is linearly dependent upon any group of N−1 of the M linear expressions. For a redundant storage set that encode N data values through M linear expressions onto M redundant storage devices of a redundant storage set, all data stored on the redundant storage set can be recovered so long as no more than N of the M redundant storage devices fails at the same time, that is, before at least one of them can be repaired.

The system of FIG. 11 includes RAID controllers (210, 212), computer modules that provide data storage on RAID sets (218, 220). RAID (Redundant Array of Independent Disks) is a standard storage device configuration originated at UC Berkeley. RAID accomplishes high performance, capacity, and/or redundancy with any of several different configurations of individual disks called ‘RAID levels.’ RAID levels commonly defined include RAID 0, RAID1, RAID2, RAID3, RAID4, and RAID5. Although various manufacturers implement various variations of RAID, these five levels represent the core functionality of RAID. A “RAID set” is a specific number of drives grouped together at a single RAID level, RAID1 or RAID5, for example. A RAID set presents itself to an operating system as an individual disk drive. A RAID set breaks up data so that it can be stored across multiple individual disk drives within the RAID set. An 80 Kb file may, for example, be broken into five 16 Kb pieces. These 16 Kb pieces are referred to as ‘stripes’ or ‘chunks.’ In writing stripes to individual disks within a RAID set, the RAID set calculates and stores parity data for the stripes so that all data in the RAID set may be recovered so long as two of the individual disk drives in the RAID set do not fail at the same time, that is, before the first to fail can be repaired.

A block of data is the quantity of data administered by a storage reliability controller, a redundant storage controller, or a RAID controller. An application program such as a database server, for example, administers data in terms of files and directories. An individual disk drive writes and reads data in sectors addressed by disk, track and sector number. An operating system maps blocks to files and directories, calling a disk driver such as a storage reliability controller, a redundant storage controller, or a RAID controller with instructions to read and write blocks of data—as opposed to files, tracks, or sectors. An individual drive or RAID controller maps blocks to disk, track, and sector and is free to write a single block that is larger than its sector size to multiple sectors on the same or different tracks or disks.

Reliability of data storage devices of differing reliabilities can be explained in terms of probabilities of failure. For a redundant storage set that encode N data values through M linear expressions onto M redundant storage devices of a redundant storage set, all data stored on the redundant storage set can be recovered so long as no more than N of the M redundant storage devices fails at the same time, that is, before at least one of the N failed devices can be repaired. The probability of at least N+1 such simultaneous failures in a redundant storage set, and therefore the probability of complete data loss in a redundant storage set, can expressed as:

$$Expression 1 \text{:}$$

$${\sum }_{k = n + 1}^{m} \frac{m !}{k ! ( m - k ) !} {{x}^{k} ( 1 - x )}^{m - k}$$

where x is the probability of a single failure of one of the redundant storage devices of the redundant storage set, m is the total number of redundant storage devices in the redundant storage set, and n is the maximum number of redundant storage devices of the redundant storage set that may fail without impacting reliability. For a redundant storage set of n=3, m=6, and x=0.01, therefore, the probability of complete data loss is 0.147591×10⁻⁶. For a redundant storage set of n=2, m=7, the probability of complete data loss is 33.951559×10⁻⁶. And a redundant storage set of n=3, m=6 is shown to be more reliable than a redundant storage set of n=2, m=7.

Similarly, the probability that two or more drives of a RAID set will fail simultaneous causing loss of all data stored on the RAID set may be expressed as:
1−((1−x)ⁿ+nx(1−x)ⁿ⁻¹) Expression 2:
where x is the probability that one drive will fail, and n is the number of drives in the RAID set. For a RAID set of six drives with x=0.01, the probability of complete data loss is 0.001460. For a RAID set of twenty drives with x=0.01, the probability of complete data loss is 0.016859. A RAID set of twenty drives therefore, given the same value of x for drives in both sets, is considered more reliable than a RAID set of six drives, and the redundant storage sets of n=2, m=7 and n=3, m=6 are both more reliable than the RAID sets of six and twenty drives, given the same value of x.

The system of FIG. 11 includes a storage reliability controller (204), a combination of computer hardware and software programmed to read and write blocks of data to and from data storage devices (214, 216, 218, 220) and to maintain a usage statistic for each block of data stored on each data storage device. In reading and writing blocks of data, storage reliability controller (204) presents itself to an operating system on database server (203) as a file system that exposes an API to the file system through a driver. The usage statistic may be implemented as any statistical indication of usage of data storage, such as, for example, counts of reads and writes to a block, a running average of reads and writes to a block over time, or a decaying average of reads and writes to a block over time.

Storage reliability controller (204) in the example of FIG. 11 is capable of moving a block of computer data from a first data storage device to a second data storage device in dependence upon a usage statistic for the moved block and the reliabilities of the first and second data storage devices. Storage reliability controller (204) may, for example, move a rarely used block of data to a storage device characterized by a reliability that is lower than the reliability of the storage device from which the block is moved. Or storage reliability controller (204) may move a frequently used block of data to a storage device characterized by a reliability that is higher than the reliability of the storage device from which the block is moved. To so move blocks of data among storage devices, storage reliability controller (204) may provide a storage reliability daemon to run in its own thread of execution and periodically or continuously scan through a list of data blocks, analyzing the usage of the blocks, and moving blocks according to their usage and the relative reliabilities of available storage devices.

The arrangement of servers and other devices making up the exemplary system illustrated in FIG. 11 are for explanation, not for limitation. In the example of FIG. 11, redundant storage controllers (206, 208) and RAID controllers (210, 212) are coupled for data communications to storage reliability controller (204) through data bus (205). Data bus (205) may be, for example, an IDE (Integrated Disk Electronics) bus or a SCSI (Small Computer System Interface) bus, or some other I/O bus design as will occur to those of skill in the art. In the example of FIG. 11, storage reliability controller (204) is represented as a separate piece of equipment from database server (203). Readers of skill in the art, however, will recognize that storage reliability controller (204), redundant storage controllers (206, 208), and RAID controllers (210, 212) may be implemented, for example, as hardware adapters all installed in the same cabinet with database server (203) with software drivers incorporated in an operating system running on the same computer processors in the same cabinet with database server (203). Alternatively, storage reliability controller (204), redundant storage controllers (206, 208), RAID controllers (210, 212), and database server (203) may be implemented as separate pieces of equipment related even more remotely, with data communications among them implemented over a network such as a SAN (Storage Area Network) rather than over buses. Data processing systems useful for storage of computer data on data storage devices of differing reliabilities according to various embodiments of the present invention may include additional servers, routers, other devices, and peer-to-peer architectures, not shown in FIG. 11, as will occur to those of skill in the art. Networks in such data processing systems may support many data communications protocols, including for example TCP/IP, HTTP, WAP, HDTP, and others as will occur to those of skill in the art. Various embodiments of the present invention may be implemented on a variety of hardware platforms in addition to those illustrated in FIG. 11.

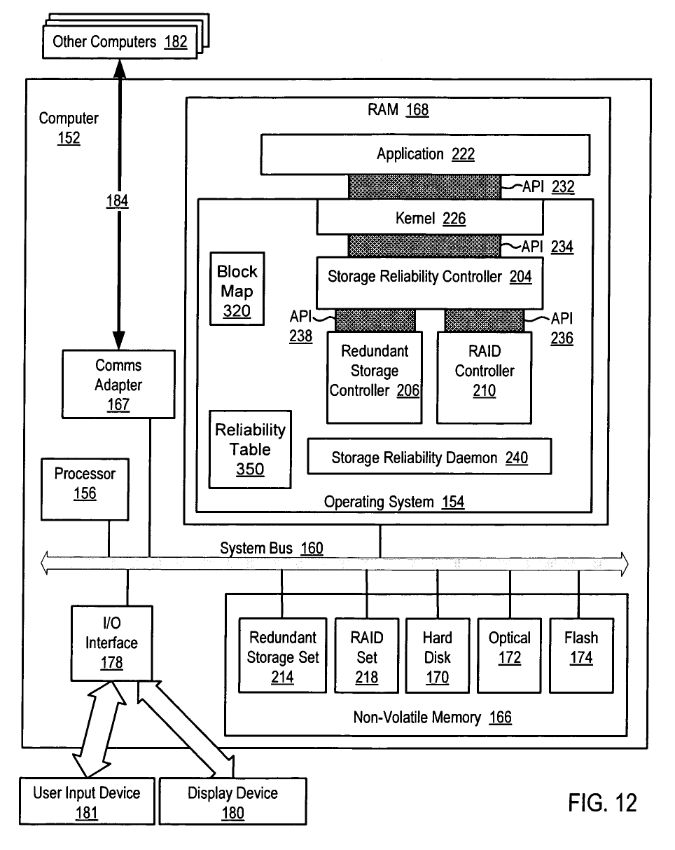

Storage of computer data on data storage devices of differing reliabilities in accordance with the present invention is generally implemented with computers, that is, with automated computing machinery. In the system of FIG. 11, for example, storage reliability controller (204), redundant storage controllers (206, 208), RAID controllers (210, 212), and database server (203) all are implemented to some extent at least as computers. For further explanation, therefore, FIG. 12 sets forth a block diagram of automated computing machinery comprising an exemplary computer (152) useful in storage of computer data on data storage devices of differing reliabilities according to embodiments of the present invention. The computer (152) of FIG. 12 includes at least one computer processor (156) or ‘CPU’ as well as random access memory (168) (“RAM”) which is connected through a system bus (160) to processor (156) and to other components of the computer.

Stored in RAM (168) is an operating system (154). Operating systems useful in computers according to embodiments of the present invention include UNIX™, Linux™, Microsoft NT™, ALX™, IBM's i5/OS™, and others as will occur to those of skill in the art. In the example of FIG. 12, operating system (154) includes a kernel (226), a storage reliability controller (204), a redundant storage controller (206), a RAID controller (210), a storage reliability daemon (240), a block map (320), and a reliability table (350). Also stored in RAM is an application program (222), such as, for example, a database management system or ‘DBMS.’

Kernel (226) is a component of the operating system that controls application access to system resources, including access to storage devices such as redundant storage set (214) or RAID set (218). Kernel (226) exposes an API (Application Programming Interface) (232) that provides operations for applications on files system objects such as files and directories. Applications may use API (232) to create, delete, open, close, read from, and write to files and directories. API (232) allows applications to view files as high level data structures. Kernel (226) maintains data structures mapping files and directories to lower-level units of data storage referred to in this specification as ‘blocks.’

Storage reliability controller (204) is a software module, in effect a storage device driver, computer program instructions that reads and writes blocks of data to and from data storage devices and to maintains a usage statistic for each block of data stored on each data storage device. In reading and writing blocks of data, storage reliability controller (204) presents itself to the kernel (226) of operating system (154) as a file system that exposes an API (234) that supports reading and writing blocks of data. The kernel maps the blocks of data to higher level structures such as files and directories. Storage reliability controller (204) uses block map (320) to map blocks stored through it to their storage locations on data storage devices. Storage reliability controller (204) may maintain a usage statistic for each block by calculating the usage statistic and storing the usage statistic in the block map (320) in association with a block identifier. The usage statistic may be implemented as any statistical indication of usage of data storage, such as, for example, counts of reads and writes to a block, a running average of reads and writes to a block over time, or a decaying average of reads and writes to a block over time.

Redundant storage controller (206) is a software module, in effect a storage device driver, computer program instructions that control redundant storage sets that in turn carry out redundant storage of computer data by encoding N data values through M linear expressions into M encoded data values, storing each encoded data value separately on one of M redundant storage devices, where M is greater than N and none of the linear expressions is linearly dependent upon any group of N−1 of the M linear expressions. RAID controller (210) is a software module, in effect a storage device driver, that provides data storage on RAID sets.

Both redundant storage controller (206) and RAID controller (210) expose to storage reliability controller (204) APIs (238, 236) that supports read and writes of blocks of data. As mentioned above, in reading and writing blocks of data, storage reliability controller (204) presents itself to an operating system as a file system that exposes to a kernel (226) an API (234) that supports reads and writes of blocks of data. In this example, storage reliability controller (204) implements a layer of storage virtualization in the operating system (154) of the computer system (152) because storage reliability controller (204) abstracts the data storage devices controlled by redundant storage controller (206) and RAID controller (210) and presents them to kernel, (226) through API (234) as a single file system. From the kernel's point of view, kernel (226) reads and writes blocks of data through API (234) to and from a single virtual file system represented by storage reliability controller (204). Storage reliability controller (204) maps block identifiers for the blocks stored by the kernel to their storage locations on data storage devices and then reads and writes those blocks to the data storage devices through redundant storage controller (206) and RAID controller (210). Redundant storage controller (206) and RAID controller (210) are effectively invisible to the kernel (226). And it is in this sense that storage reliability controller (204) implements a layer of storage virtualization in operating system (154).

Storage reliability daemon (240) is a software module, computer program instructions that run periodically or continuously in their own thread of execution and move blocks of computer data among data storage devices in accordance with the usage statistics for the blocks and the reliabilities of the data storage devices. Storage reliability daemon (240) may, for example, move a rarely used block of data to a storage device characterized by a reliability that is lower than the reliability of the storage device from which the block is moved. Or storage reliability daemon (240) may move a frequently used block of data to a storage device characterized by a reliability that is higher than the reliability of the storage device from which the block is moved. Storage reliability daemon (240) may so move blocks among data storage devices by scanning through a list of data blocks (a list in a block map, for example), analyzing the usage of the blocks, and moving blocks according to their usage and the relative reliabilities of available storage devices.

Block map (320) is a data structure, typically a table, each record of which represents a mapping of a block of stored data to the block's location on a data storage device. A block map representing mappings of blocks of stored data to the blocks' locations on data storage devices (214, 216, 218, 220 on FIG. 11) may be implemented as shown in Table 1:

TABLE 1
An Example Block Map

| | Storage Location | | | |
|---|---|---|---|---|
| | | Storage | | |
| | Storage | Device | Decaying | |
| Block ID | Device ID | Block ID | Average | Time Stamp |
| 45 | 214 | 1 | 5.543 | 120436.005 |
| 32 | 214 | 2 | 0.998 | 041327.994 |
| 654 | 214 | 3 | 7.321 | 193554.908 |
| . . . | . . . | . . . | . . . | . . . |
| 98765 | 216 | 1 | 0.010 | 235645.354 |
| 4567 | 216 | 2 | 3.897 | 000437.453 |
| 7665 | 216 | 3 | 9.324 | 094433.443 |
| . . . | . . . | . . . | . . . | . . . |
| 43 | 218 | 1 | 12.354 | 154312.342 |
| 456 | 218 | 2 | 27.564 | 020422.564 |
| 765 | 218 | 3 | 0.022 | 042226.897 |
| . . . | . . . | . . . | . . . | . . . |
| 234 | 220 | 1 | 0.001 | 074432.675 |
| 123 | 220 | 2 | 342.675 | 162153.683 |
| 432 | 220 | 3 | 1022.564 | 100434.691 |
| . . . | . . . | . . . | . . . | . . . |

A typical block map will contain too many records to illustrate here. For convenience of explanation, therefore, the block map of Table 1 illustrates mappings of blocks of stored data to only the first three storage locations on the four data storage devices represented at references (214, 216, 218, 220) on FIG. 11. Table 1 contains five columns:
a column named “Block ID” that stores the block identifier used by the kernel. This is the block identifier of the block as stored in the virtual storage space presented to the kernel by reliability storage controller (204) through API (234).
a column named “Storage Device ID” that stores an identifier for the data storage device on which the block of data is currently stored.
a column named “Storage Device Block ID” that stores the block identifier for the block on the storage device where the block is currently stored. The storage Device ID and the Storage Device Block ID taken together represent the current storage location of the block of data. After moving a block, a storage reliability daemon need only update the storage location, the Storage Device ID and the Storage Device Block ID to record the location to which a block is moved. The move is invisible to the kernel, the operating system, and any application using the block because the Block ID in the leftmost column of the block map, the Block ID as used by the kernel, remains unchanged. Only the mapping changes, and the change in the mapping is never known to the kernel, the application, or to other components of the operating system.
a column named “Decaying Average” that stores a usage statistic that measures usage of a block of stored data with a decaying average.
and a column named “Time Stamp” that stores the time when the last value of the decaying average was calculated. The current value of the decaying average, the time stamp, and the current time are used by storage reliability controller (204) to calculate a new value for the decaying average when the storage reliability controller reads or writes a block of data.

Reliability table (350) is a data structure, a table, each record of which represents a reliability of a data storage device. A reliability table representing the four reliabilities calculated above for the data storage devices (214, 216, 218, 220 on FIG. 11) may be implemented as shown in Table 2:

TABLE 2
An Example Reliability Table

| Storage Device ID | Reliability |
|---|---|
| 214 | 0.147591 × 10⁻⁶ |
| 216 | 33.951559 × 10⁻⁶ |
| 218 | 0.001460 |
| 220 | 0.016859 |

In the example of FIG. 12, operating system (154), kernel (226), storage reliability controller (204), redundant storage controller (206), RAID controller (210), storage reliability daemon (240), block map (320), reliability table (350), and application (222) are shown in RAM (168). Readers will recognize, however, that many components of such software may be stored in non-volatile memory (166) also.

Computer (152) of FIG. 12 includes non-volatile computer memory (166) coupled through a system bus (160) to processor (156) and to other components of the computer (152). Non-volatile computer memory (166) may be implemented as a hard disk drive (170), optical disk drive (172), electrically erasable programmable read-only memory space (so-called ‘EEPROM’ or ‘Flash’ memory) (174), RAM drives (not shown), or as any other kind of computer memory as will occur to those of skill in the art.

The example computer of FIG. 12 includes one or more input/output interface adapters (178). Input/output interface adapters in computers implement user-oriented input/output through, for example, software drivers and computer hardware for controlling output to display devices (180) such as computer display screens, as well as user input from user input devices (181) such as keyboards and mice.

The exemplary computer (152) of FIG. 12 includes a communications adapter (167) for implementing data communications (184) with other computers (182). Such data communications may be carried out through serially through RS-232 connections, through external buses such as USB, through data communications networks such as IP networks, and in other ways as will occur to those of skill in the art. Communications adapters implement the hardware level of data communications through which one computer sends data communications to another computer, directly or through a network. Examples of communications adapters useful for determining availability of a destination according to embodiments of the present invention include modems for wired dial-up communications, Ethernet (IEEE 802.3) adapters for wired network communications, and 802.11b adapters for wireless network communications.

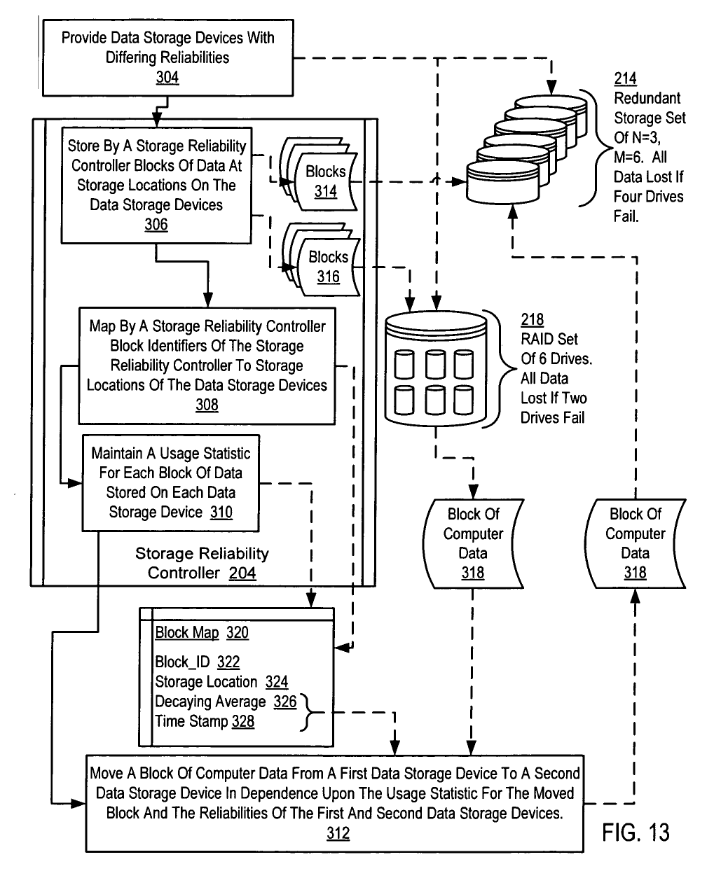

For further explanation, FIG. 13 sets forth a flow chart illustrating an exemplary method for storage of computer data on data storage devices of differing reliabilities according to embodiments of the present invention that includes providing (304) data storage devices (214, 218) characterized by differing reliabilities. In the example of FIG. 13, each data storage device stores blocks of computer data at storage locations on the data storage device. Data storage device (214) is a redundant storage set that makes portions of storage media available for redundant storage of data by encoding N data values through M linear expressions into M encoded data values, storing each encoded data value separately on one of M redundant storage devices, where M is greater than N and none of the linear expressions is linearly dependent upon any group of N−1 of the M linear expressions. In the example of redundant storage set (214), N=3 and M=6. Data storage device (218) is a RAID set of 6 drives. As described above in more detail, with reliabilities expressed as probabilities of data loss, the reliability of redundant storage set (214) is 0.147591×10⁻⁶, and the reliability of RAID set (218) is 0.016859. Redundant storage set (214) is more reliable than RAID set (218).

The method of FIG. 13 also includes storing (306) by a storage reliability controller (204) blocks (314, 316) of data at storage locations on the data storage devices (218, 214). The storage reliability controller (204) implements a layer of storage virtualization in an operating system of a computer as described in more detail above in this specification. The method of FIG. 13 also includes mapping (308) by the storage reliability controller (204) block identifiers of the storage reliability controller to storage locations of the data storage devices. Mapping (308) block identifiers to storage locations may be carried out by use of a data structure like the one illustrated at reference (320) of FIG. 13, a data structure having fields for a block identifier (322) and a storage location (324) where the block is stored on a data storage device. Such mapping may also be carried out as described in detail above in this specification with reference to Table 1.

The method of FIG. 13 also includes maintaining (310) a usage statistic for each block of data stored on each data storage device. In the example of FIG. 13, the usage statistic is a decaying average (326). Storage reliability controller (204) maintains the usage statistic by recalculating it and storing it in a data structure like the one illustrated at reference (320) on FIG. 13 each time the storage reliability controller reads or writes a block of data from or to a data storage device. A decaying average usage statistic may be calculated upon reading or writing a block of data according to:
A_{DB}←A_{DB}F^{T}^{_{C}}^{-T}^{_{S}}+1 Expression 3:
where:
A_{DB} is the decaying average for a block of data,
←is an assignment operator,
T_{C} is the current time when the decaying average is calculated,
T_{S}, mnemonic for ‘time stamp,’ specifying the time when the decaying average for the block was last calculated, and
F is a decay factor that sets the rate of decay of the decaying average. F is selected to be less than one.

Expression 3 describes an iterative algorithm: From a data structure like Table 1 that stores a decaying average for a block and a time stamp when the decaying average was last calculated, read the previously calculated decaying average, multiply it by the decay factor F raised to the (T_{C}−T_{S})th power, add one, and record the sum as the new decaying average for a current read or write of the block. Then record the current time T_{C} as the new time stamp T_{S} specifying when the decaying average was last calculated.

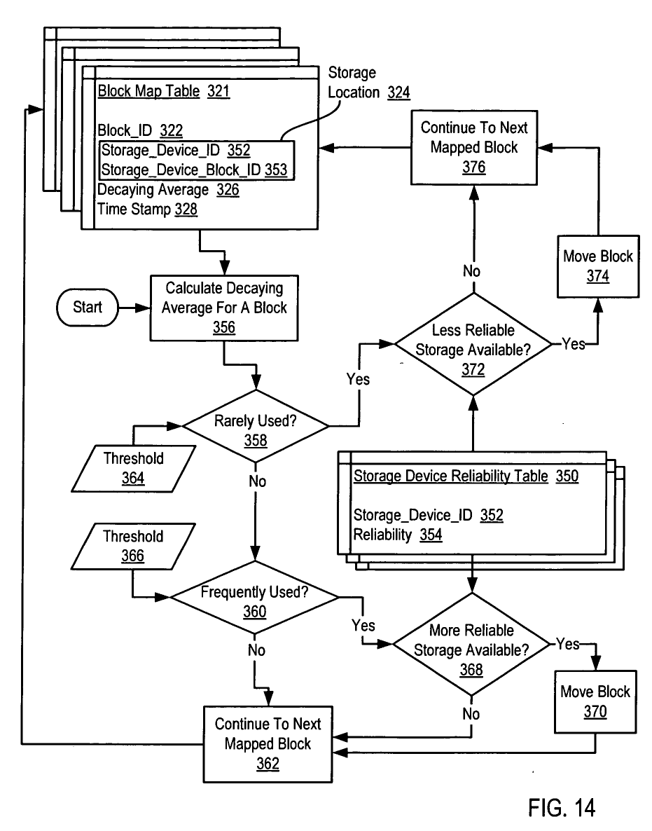

The method of FIG. 13 also includes moving (312) a block (318) of computer data from a first data storage device (218) to a second data storage device (214) in dependence upon the usage statistic for the moved block and the reliabilities of the first and second data storage devices. The moving process in this example uses a decaying average usage statistic (326) and a time stamp (328) specifying the last time the decaying average was calculated to determine whether to move a block. For further explanation, FIG. 14 sets forth a flow chart illustrating an exemplary method for moving a block of computer data from a first data storage device to a second data storage device in dependence upon the usage statistic for the moved block and the reliabilities of the first and second data storage devices. In the method of FIG. 14, moving a block of computer data from a first data storage device to a second data storage device in dependence upon the usage statistic for the moved block and the reliabilities of the first and second data storage devices is carried out by moving a rarely used block of data to a storage device characterized by a reliability that is lower than the reliability of the storage device from which the block is moved. Also in the method of FIG. 14, moving a block of computer data from a first data storage device to a second data storage device in dependence upon the usage statistic for the moved block and the reliabilities of the first and second data storage devices is carried out by moving a frequently used block of data to a storage device characterized by a reliability that is higher than the reliability of the storage device from which the block is moved.

The method of FIG. 14 operates generally, either periodically or in a continuous loop in its own thread of execution such as for example a storage reliability daemon (240 on FIG. 12), by scanning through a block map table and determining for each block of stored data represented by a record of the table whether the block is rarely or frequently used and moving (or not moving) the block according to that determination. More particularly, the method of FIG. 14 includes calculating a decaying average or a block. A decaying average usage statistic may be calculated for purposes of deciding whether to move a block according to:
A_{DB}←A_{DB}F^{T}^{_{C}}^{-T}^{_{S}} Expression 4:
where:
A_{DB} is the decaying average for a block of data,
← is an assignment operator,
T_{C} is the current time when the decaying average is calculated,
T_{S}, mnemonic for ‘time stamp,’ specifying the time when the decaying average for the block was last calculated, and
F is a decay factor that sets the rate of decay of the decaying average. F is selected to be less than one.

Expression 4 is similar to Expression 3 except that 1 is not added to the moving average because, when deciding whether to move a block, no usage of the block is involved, no read or write. There is no need to increment the usage statistic to represent usage because determining whether to move a block is not usage of the block, not a read or write of the block.

Expression 4 describes an iterative algorithm: From a data structure like Table 1 that stores a decaying average for a block and a time stamp specifying when the decaying average was last calculated, read the previously calculated decaying average, and multiply it by the difference between the current time and the time stamp to the Fth power. That product is the decaying average for use in determining whether to move the block.

The method of FIG. 14 includes determining whether the block is rarely used by comparing (358) the decaying average usage statistic for the block with a rare use threshold (364). The rare use threshold is a configuration parameter set by a system administrator according to actual system performance. Consider an example with the rare use threshold is set to 0.5. In such an example, a block with a decaying average of 0.3 would be identified as a block that is rarely used. In such an example, a block with a decaying average of 12.5 would not be identified as a block that is rarely used.

When a block is identified as a block that is rarely used, the method of FIG. 14 continues by determining, by comparison (372) with the data storage device where the block is currently stored, whether less reliable storage is available. The block map table (321) stores the current storage location (324) of the block as a storage device identifier (352) and a storage device block identifier (353). The storage device identifier (352) for the block is used as an index for a lookup, in storage device reliability table (350), of the reliability (354) for the data storage device where the block is currently stored. The method of FIG. 14 then scans through table (350) to search for a storage device having a lower reliability than the storage device where the block is currently stored. If less reliable storage is available, the method of FIG. 14 moves (374) the block to a less reliable data storage device, updates block map table (321) with a new storage location (324) for the block, and continues (376) to examine the next mapped block in the block map table (321). If no less reliable storage is available, the method of FIG. 13 continues (376) to examine the next mapped block in the block map table (321) without moving the block for which no less reliable storage was found.

When a block is not identified as a block that is rarely used, the method of FIG. 14 continues by determining whether the block is frequently used by comparing (360) the decaying average usage statistic for the block with a frequent use threshold (366). The frequent use threshold is a configuration parameter set by a system administrator according to actual system performance. Consider an example with the frequent use threshold is set to 10.0. In such an example, a block with a decaying average of 0.3 would not be identified as a block that is frequently used. In such an example, a block with a decaying average of 12.5 would be identified as a block that is frequently used.

When a block is identified as a block that is frequently used, the method of FIG. 14 continues by determining, by comparison (368) with the data storage device where the block is currently stored, whether less reliable storage is available. The block map table (321) stores the current storage location (324) of the block as a storage device identifier (352) and a storage device block identifier (353). The storage device identifier (352) for the block is used as an index for a lookup, in storage device reliability table (350), of the reliability (354) for the data storage device where the block is currently stored. The method of FIG. 14 then scans through table (350) to search for a storage device with a higher reliability than the storage device where the block is currently stored. If more reliable storage is available, the method of FIG. 14 moves (370) the block to a more reliable data storage device, updates block map table (321) with a new storage location (324) for the block, and continues (362) to examine the next mapped block in the block map table (321). If more reliable storage is not available, the method of FIG. 14 continues (362) to examine the next mapped block in the block map table (321) without moving the block for which more reliable storage is not found.

When a block is not identified as a block that is rarely used and the block is not identified as a block that is frequently used, the method of FIG. 14 continues (376) to examine the next mapped block in the block map table (321) without moving a block determined to be neither rarely nor frequently used.

Exemplary embodiments of the present invention are described largely in the context of a fully functional computer system for storage of computer data on data storage devices of differing reliabilities. Readers of skill in the art will recognize, however, that the present invention also may be embodied in a computer program product disposed on signal bearing media for use with any suitable data processing system. Such signal bearing media may be transmission media or recordable media for machine-readable information, including magnetic media, optical media, or other suitable media. Examples of recordable media include magnetic disks in hard drives or diskettes, compact disks for optical drives, magnetic tape, and others as will occur to those of skill in the art. Examples of transmission media include telephone networks for voice communications and digital data communications networks such as, for example, Ethernets™ and networks that communicate with the Internet Protocol and the World Wide Web. Persons skilled in the art will immediately recognize also that any computer system having suitable programming means will be capable of executing the steps of the method of the invention as embodied in a program product. Persons skilled in the art also will recognize immediately that, although some of the exemplary embodiments described in this specification are oriented to software installed and executing on computer hardware, nevertheless, alternative embodiments implemented as firmware or as hardware are well within the scope of the present invention.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method for storage of computer data on data storage devices of differing reliabilities, the method comprising:
providing data storage devices, each data storage device having blocks of computer data stored at storage locations on the data storage device, the data storage devices characterized by differing reliabilities;
maintaining a usage statistic for each block of data stored on each data storage device; and
moving a block of computer data from a first data storage device to a second data storage device in dependence upon the usage statistic for the moved block and the reliabilities of the first and second data storage devices.

2. The method of claim 1 wherein the data storage devices include a RAID (Redundant Array of Independent Disks) set accessed through a RAID controller.

3. The method of claim 1 wherein the data storage devices include a redundant storage set accessed through a redundant storage controller.

4. The method of claim 1 further comprising:
storing by a storage reliability controller blocks of data at storage locations on the data storage devices, the storage reliability controller comprising a layer of storage virtualization in an operating system of the computer system; and
mapping by the storage reliability controller block identifiers of the storage reliability controller to storage locations of the data storage devices.

5. The method of claim 1 wherein maintaining a usage statistic for each block of data stored on each data storage device further comprises maintaining the statistic by a storage reliability controller, the storage reliability controller comprising a layer of storage virtualization in an operating system of the computer system.

6. The method of claim 1 wherein the usage statistic is a decaying average.

7. The method of claim 1 wherein moving a block of computer data from a first data storage device to a second data storage device in dependence upon the usage statistic for the moved block and the reliabilities of the first and second data storage devices further comprises:
moving a rarely used block of data to a storage device characterized by a reliability that is lower than the reliability of the storage device from which the block is moved.

8. The method of claim 1 wherein moving a block of computer data from a first data storage device to a second data storage device in dependence upon the usage statistic for the moved block and the reliabilities of the first and second data storage devices further comprises moving a frequently used block of data to a storage device characterized by a reliability that is higher than the reliability of the storage device from which the block is moved.

9. A system for storage of computer data on data storage devices of differing reliabilities, the system comprising a computer processor and a computer memory operatively coupled to the computer processor, the computer memory having disposed within it computer program instructions capable of:
providing data storage devices, each data storage device having blocks of computer data stored at storage locations on the data storage device, the data storage devices characterized by differing reliabilities;
maintaining a usage statistic for each block of data stored on each data storage device; and
moving a block of computer data from a first data storage device to a second data storage device in dependence upon the usage statistic for the moved block and the reliabilities of the first and second data storage devices.

10. The system of claim 9 wherein the data storage devices include a RAID (Redundant Array of Independent Disks) set accessed through a RAID controller.

11. The system of claim 9 wherein the data storage devices include a redundant storage set accessed through a redundant storage controller.

12. The system of claim 9 further comprising computer program instructions capable of:
storing by a storage reliability controller blocks of data at storage locations on the data storage devices, the storage reliability controller comprising a layer of storage virtualization in an operating system of the computer system; and
mapping by the storage reliability controller block identifiers of the storage reliability controller to storage locations of the data storage devices.

13. The system of claim 9 wherein maintaining a usage statistic for each block of data stored on each data storage device further comprises maintaining the statistic by a storage reliability controller, the storage reliability controller comprising a layer of storage virtualization in an operating system of the computer system.

14. A computer program product for storage of computer data on data storage devices of differing reliabilities, the computer program product disposed upon a signal bearing device, the computer program product comprising computer program instructions capable of:
providing data storage devices, each data storage device having blocks of computer data stored at storage locations on the data storage device, the data storage devices characterized by differing reliabilities;
maintaining a usage statistic for each block of data stored on each data storage device; and
moving a block of computer data from a first data storage device to a second data storage device in dependence upon the usage statistic for the moved block and the reliabilities of the first and second data storage devices.

15. The computer program product of claim 14 wherein the signal bearing device comprises a recordable device.

16. The computer program product of claim 14 wherein the signal bearing device comprises a transmission device.

17. The computer program product of claim 14 further comprising computer program instructions capable of:
storing by a storage reliability controller blocks of data at storage locations on the data storage devices, the storage reliability controller comprising a layer of storage virtualization in an operating system of the computer system; and
mapping by the storage reliability controller block identifiers of the storage reliability controller to storage locations of the data storage devices.

18. The computer program product of claim 14 wherein the usage statistic is a decaying average.

19. The computer program product of claim 14 wherein moving a block of computer data from a first data storage device to a second data storage device in dependence upon the usage statistic for the moved block and the reliabilities of the first and second data storage devices further comprises moving a rarely used block of data to a storage device characterized by a reliability that is lower than the reliability of the storage device from which the block is moved.

20. The computer program product of claim 14 wherein moving a block of computer data from a first data storage device to a second data storage device in dependence upon the usage statistic for the moved block and the reliabilities of the first and second data storage devices further comprises moving a frequently used block of data to a storage device characterized by a reliability that is higher than the reliability of the storage device from which the block is moved.
